(19) United States
(12) Patent Application Publication
(10) Pub. No.: US 2026/0203850 A1
(43) Pub. Date: Jul. 16, 2026

(54) GRAPHICS PROCESSING UNIT AND OPERATING METHOD THEREOF

(71) Applicants: SAMSUNG ELECTRONICS CO., LTD., Suwon-si (KR); Seoul National University R&DB FOUNDATION, Seoul (KR)

(72) Inventors: Jaewoong SIM, Seoul (KR); Junseo LEE, Seoul (KR); Jaisung KIM, Seoul (KR); Junyong PARK, Seoul (KR)

(73) Assignees: SAMSUNG ELECTRONICS CO., LTD., Suwon-si (KR); Seoul National University R&DB FOUNDATION, Seoul (KR)

(21) Appl. No.: 19/352,990

(22) Filed: Oct. 8, 2025

(30) Foreign Application Priority Data
Jan. 13, 2025 (KR) 10-2025-0005021
Mar. 27, 2025 (KR) 10-2025-0039661

(51) Int. Cl. G06T 1/20; G06V 10/56

(52) U.S. Cl. CPC G06T 1/20; G06V 10/56

(57) ABSTRACT

A graphics processing unit (GPU) and an operating method thereof, including: a termination test circuit configured to: receive, from a memory, an early termination value of a first pixel included in an output image, and to output a termination test result by performing a termination test on a first fragment associated with the first pixel based on the early termination value; a blending circuit configured to, based on the termination test result, determine a new pixel value of the first pixel by performing blending using the first fragment, or to omit the blending; an alpha test circuit configured to perform an alpha test by comparing an alpha value of the new pixel value to a threshold value when the blending is performed, and to output an alpha test result; and a termination update circuit configured to update the early termination value based on the alpha test result indicating an early termination.

### CROSS-REFERENCE TO RELATED APPLICATION

This application is based on and claims priority under 35 U.S.C. § 119 to Korean Patent Application No. 10-2025-0005021, filed on Jan. 13, 2025, and Korean Patent Application No. 10-2025-0039661, filed on Mar. 27, 2025, in the Korean Intellectual Property Office, the disclosures of which are incorporated by reference herein in their entireties.

### BACKGROUND

### 1. Field

The disclosure to a graphics processing unit (GPU) and an operating method thereof.

### 2. Description of Related Art

A graphics processing unit (GPU) may be used to quickly render images, videos, and three-dimensional (3D) graphics. A GPU may provide a parallel operation that uses numerous cores and may be used fields such as artificial intelligence (AI), deep learning, and scientific computing, in addition to graphics. A rendering pipeline may represent a process of outputting a 3D graphic to a two-dimensional (2D) screen. For example, a rendering pipeline may include vertex processing, rasterization, pixel shading, etc. A rendering pipeline may be processed using a GPU.

### SUMMARY

One or more embodiments may address at least the above problems and/or disadvantages and other disadvantages not described above. Also, the embodiments are not required to overcome the disadvantages described above, and an embodiment may not overcome any of the problems described above.

In accordance with an aspect of the disclosure, a graphics processing unit (GPU) includes: a termination test circuit configured to: receive, from a memory, an early termination value of a first pixel included in an output image, and to output a termination test result by performing a termination test on a first fragment associated with the first pixel based on the early termination value; a blending circuit configured to, based on the termination test result, determine a new pixel value of the first pixel by performing blending using the first fragment, or to omit the blending; an alpha test circuit configured to perform an alpha test by comparing an alpha value of the new pixel value to a threshold value when the blending is performed, and to output an alpha test result; and a termination update circuit configured to update the early termination value based on the alpha test result indicating an early termination.

In accordance with an aspect of the disclosure, an operating method of a graphics processing unit (GPU) includes: receiving, from a memory, an early termination value of a first pixel included an output image; based on the early termination value, generating a termination test result by performing a termination test on a first fragment associated with the first pixel; determining a new pixel value of the first pixel by performing blending using the first fragment based on the termination test result; performing an alpha test by comparing an alpha value of the new pixel value to a threshold value; and updating the early termination value based on a result of the alpha test indicating an early termination.

### BRIEF DESCRIPTION OF THE DRAWINGS

The above and/or other aspects, features, and advantages of certain embodiments of the present disclosure will be more apparent from the following description taken in conjunction with the accompanying drawings, in which:

FIG. 1 is a diagram illustrating an example of an architecture of a graphics processing unit (GPU), according to an embodiment;

FIG. 2 is a diagram illustrating an example of a graphics rendering process based on a graphics pipeline, according to an embodiment;

FIG. 3 is a diagram illustrating an example of a processing process of Gaussian splatting based on a graphics pipeline, according to an embodiment;

FIG. 4 is a diagram illustrating an example of an early termination using an alpha value, according to an embodiment;

FIG. 5 is a diagram illustrating an example of a configuration of a GPU that performs an early termination, according to an embodiment;

FIG. 6 is a diagram illustrating an example of a process of updating an early termination value of a predetermined pixel, according to an embodiment;

FIG. 7 is a diagram illustrating an example of a process of omitting the processing of a fragment of a predetermined pixel based on an early termination value of the predetermined pixel, according to an embodiment;

FIG. 8 is a diagram illustrating a detailed example of early termination processing, according to an embodiment;

FIG. 9 is a diagram illustrating an example of configurations of a GPU that performs a hierarchical early termination, according to an embodiment; and

FIG. 10 is a flowchart illustrating an example of an operating method of a GPU, according to an embodiment.

### DETAILED DESCRIPTION

The following detailed structural or functional description is provided as an example only, and various alterations and modifications may be made to the particular embodiments described herein. Accordingly, the disclosure is not to be construed as limited to these particular embodiments, and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, or the first component may be directly “connected”, “coupled”, or “joined” to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C”, and the like, each of which may include any one of the items listed together in the corresponding one of the phrases, or all possible combinations thereof. As used herein, expressions such as “at least one of”, when preceding a list of elements, modify the entire list of elements and do not modify the individual elements of the list. For example, the expression, “at least one of A, B, and C”, should be understood as including only A, only B, only C, both A and B, both A and C, both B and C, or all of A, B, and C.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing embodiments with reference to the accompanying drawings, like reference numerals refer to like components and a redundant or duplicative description related thereto may be omitted.

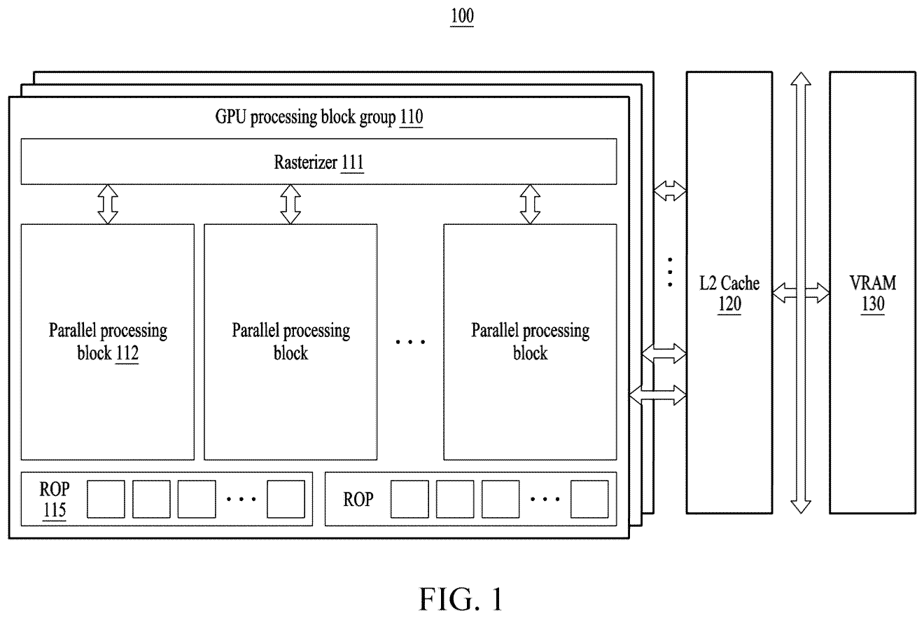

FIG. 1 is a diagram illustrating an example of an architecture of a graphics processing unit (GPU), according to an embodiment. Referring to FIG. 1, a GPU 100 may include a plurality of GPU processing block groups, a Level 2(L 2 ) cache 120, and video random-access memory (VRAM) 130. However, the architecture of the GPU 100 illustrated in FIG. 1 is an example, and the GPU 100 may have different architectures.

A GPU processing block group 110 may include a rasterizer 111, a plurality of parallel processing blocks, and a plurality of raster operation pipelines (ROPs). For example, the GPU processing block group 110 may include a graphics processing cluster (GPC), and the parallel processing blocks may include a texture processing cluster (TPC). However, embodiments are not limited thereto.

A parallel processing block 112 may perform geometry processing and texture processing on a graphics pipeline. The parallel processing block 112 may include parallel cores. For example, the parallel processing block 112 may include a polymorph and a plurality of streaming multiprocessors (SMs), but embodiments are not limited thereto. The rasterizer 111, the parallel processing block 112, the polymorph, the SMs, and an ROP 115 may each correspond to a hardware configuration. For example, the rasterizer 111, the polymorph, the SMs, and the ROP 115 may each include a hardware circuit and/or a hardware logic. The rasterizer 111, the polymorph, the SMs, and the ROP 115 may be physically separated from each other, or logically separated from each other, but embodiments are not limited thereto.

The rasterizer 111 may perform rasterization. Rasterization may refer to a rendering operation that transforms geometric data (e.g., vertex, etc.) of 3-dimensional (3D) graphics (e.g., a 3D model, a 3D scene, etc.) into fragments for a two-dimensional (2D) output image. The rasterizer 111 may generate an output image by transforming the geometric data of 3D graphics into a pixel unit.

The parallel processing block 112 may perform texture filtering and sampling. The parallel processing block 112 may contribute to a process of generating the output image by combining pixels and textures. The parallel processing block 112 (e.g., a polymorph) may accelerate geometric processing. For example, the parallel processing block 112 (e.g., a polymorph) may perform tessellation, vertex transformation, viewport transformation, etc., but embodiments are not limited thereto. The parallel processing block 112 (e.g., an SM) is a main operation unit of the GPU 100 and may perform a shader operation (e.g., vertex shading, fragment shading, etc.). The parallel processing block 112 (e.g., an SM) may include an arithmetic logic unit (ALU) and may perform a parallel operation.

The ROP 115 may determine the final pixel value of each pixel of the output image and may output the output image to a screen. The ROP 115 may perform Z-buffer (depth-buffer) processing, anti-aliasing, blending, etc., but embodiments are not limited thereto.

The GPU 100 may include a general-purpose programmable core (e.g., the parallel processing block 112 (e.g., an SM)) and a fixed-function hardware unit (e.g., the rasterizer 111, the parallel processing block 112 (e.g., a polymorph), and the ROP 115). The fixed-function hardware unit may not be controlled by a general-purpose computing framework, such as a compute unified device architecture (CUDA) or open computing language (OpenCL), and may only be used in a graphics pipeline determined using a graphics application programming interface (API), such as OpenGL, Vulkan, and Direct3D.

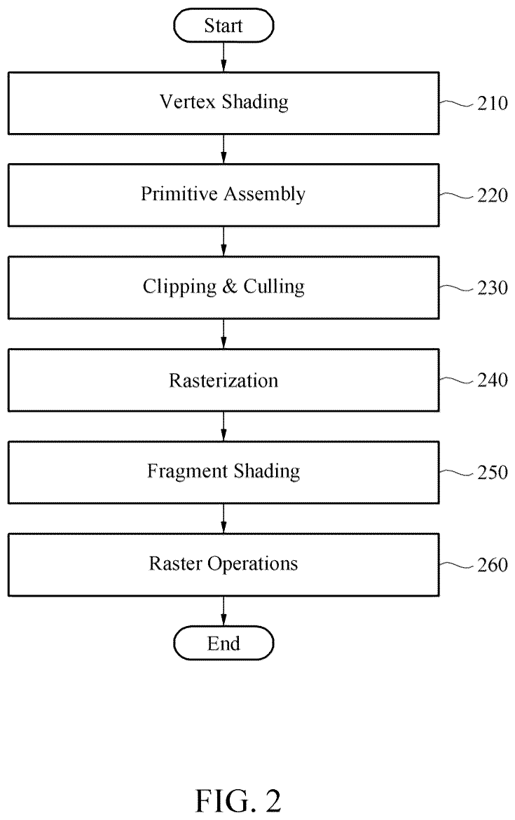

FIG. 2 is a diagram illustrating an example of a graphics rendering process based on a graphics pipeline, according to an embodiment. Referring to FIG. 2, at operation 210, vertex shading may be performed. Vertex shading may correspond to vertex processing. Vertex shading may refer to a process of performing a transformation and calculation on the position, color, normal, texture coordinate, and the like of each vertex of geometric data in a 3D graphic. Vertex shading may be performed by a vertex shader. The vertex shader may be implemented by parallel processing blocks (e.g., SMs).

At operation 220, a primitive assembly may be performed. The primitive assembly may correspond to vertex post-processing. The primitive assembly may be a process of connecting vertices to graphics primitives such as triangles. The primitive assembly may be performed by a rasterizer.

At operation 230, clipping and culling may be performed. Clipping and culling may correspond to vertex post-processing. Clipping may refer to a process of cutting out a portion outside a viewport of a camera, and culling may be a process of removing invisible primitives. Clipping and culling may be performed by the rasterizer.

At operation 240, rasterization may be performed. Rasterization may refer to a process of transforming primitives into fragments. During this process, the fragments in each primitive may be determined, and the color, depth, texture coordinate, and the like may be calculated through interpolation. Rasterization may be performed by the rasterizer.

At operation 250, fragment shading may be performed. Fragment shading may refer to a process of calculating the final color of a fragment. During this process, visual processing, such as illumination operations, texture mapping, shadow effects, anti-aliasing, and the like, may be performed. Fragment shading may be performed by a fragment shader. The fragment shader may be implemented by the parallel processing blocks (e.g., SMs).

At operation 260, raster operations may be performed. The raster operations may correspond to per-fragment processing. The raster operations may refer to a final processing process for pixel data after fragment shading. During this process, a depth test (which may be referred to as a Z-test), a stencil test, blending, anti-aliasing, and the like may be performed. The raster operations may be performed by an ROP.

For example, when a draw call occurs due to a graphics API, the vertex shader may transform, into a clip space, a triangle defined in a 3D space or a vertex of a different type of primitive. In the vertex post-processing stage, the primitives may be generated using the vertex coordinates calculated by the vertex shader, and through clipping and culling, the primitives that do not exist inside the view frustum of a current viewpoint may be removed, or a portion of the primitives may be left. The parallel processing block (e.g., a polymorph) may perform an operation such as vertex fetching and viewport transformation, and may pass the final primitive to the next pipeline stage.

The rasterizer may generate fragments by finding pixels that exist inside a primitive that is projected onto the screen. The generated fragments may be blended or overwritten with an old pixel value in the ROP using the fragment shader.

The ROP hardware may have a hardware unit for a depth test and/or a stencil test. The hardware unit may perform the depth test and the stencil test. The depth test may be used so that only a frontmost pixel is rendered when rendering is performed. The stencil test may be used to mask a predetermined pixel or implement special effects. In some cases, optimization processes for performing the depth test or the stencil test before fragment shading for rendering optimization may be used. These processes may be referred to as early Z and early stencil, respectively. Using these processes, fragments that do not require fragment shading may be removed early, and unnecessary shading or unnecessary raster operations may be effectively reduced.

An early termination may be used in volume rendering or the like. The early termination may also be referred to as an early ray termination. The early termination may be an optimization technique in which the blending of fragments may be terminated early to improve rendering performance because, when an alpha value of a predetermined pixel becomes greater than a predetermined threshold while accumulating alpha values of fragments of each pixel through blending, the fragments to be accumulated thereafter may have little effect on the pixel color. The alpha value may indicate or otherwise correspond to transparency.

According to an embodiment, a hardware-based early termination may be provided. For example, a GPU architecture and a graphics pipeline using the same may be optimized for opaque mesh-based rendering, and may be less efficient in a case in which many fragments must be blended per pixel, such as volume rendering. In particular, such a GPU architecture and the graphics pipeline using the same may not support an early termination. According to an embodiment, a GPU architecture for an early termination and a graphics pipeline using the same may be provided. Due to such a hardware-based early termination, the number of fragments requiring processing may be reduced, thereby improving rendering performance.

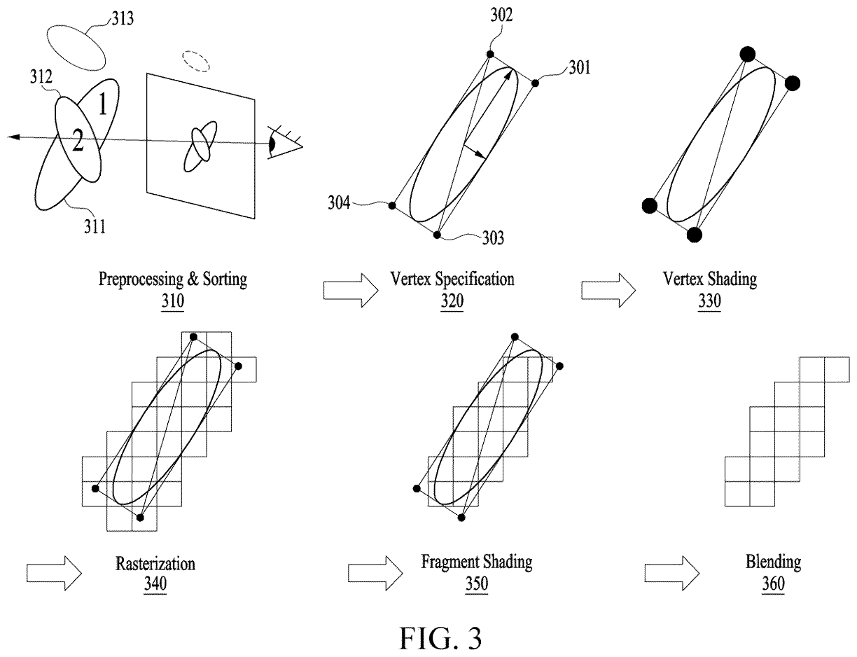

FIG. 3 is a diagram illustrating an example of a processing process of Gaussian splatting based on a graphics pipeline, according to an embodiment. Gaussian splatting may refer to a splat-based rendering process, and an output image may be generated while each splat is mixed in a 2D Gaussian form.

Referring to FIG. 3, at operation 310, preprocessing and sorting may be performed. During the preprocessing process, 3D graphics may be transformed into a set of Gaussians. Each Gaussian may have properties such as a position, size, direction, color, transparency, etc. For example, a first Gaussian 311, a second Gaussian 312, and a third Gaussian 313 may be determined from the 3D graphics through preprocessing. During the sorting process, each Gaussian may be sorted in the depth order from a camera viewpoint. For example, the first Gaussian 311 may be sorted before the second Gaussian 312.

At operation 320, a vertex specification may be performed. For the vertex specification, each Gaussian may be transformed into a 2D ellipse in a screen space, and vertices may be specified from the 2D ellipse. For example, as shown in FIG. 3, four vertices (e.g., a vertex 301, a vertex 302, a vertex 303, and a vertex 304) may be specified. A viewport transformation and/or projection may be performed for the vertex specification.

At operation 330, vertex shading may be performed. For vertex shading, each Gaussian splat may be transformed from the screen space into a position to be rendered. A 3D coordinate may be transformed into a 2D coordinate through a projection transformation. The properties of each Gaussian, such as an ellipse size, rotation, color, and the like, may be used.

At operation 340, rasterization may be performed. Each Gaussian may be decomposed into a fragment unit. At operation 350, fragment shading may be performed. A Gaussian function may be applied to each fragment, and the color and transparency of each fragment may be determined. Illumination and texture mapping may be performed. At operation 360, blending may be performed. The final color of each pixel may be determined by blending the fragments in the order of the sorted Gaussians.

According to an embodiment, a hardware-based early termination may be performed so that shading and/or blending of some fragments may be omitted. The early termination according to an embodiment may be used for various rendering processes that use transparency (e.g., an alpha value), in addition to volume rendering such as Gaussian splatting of FIG. 3.

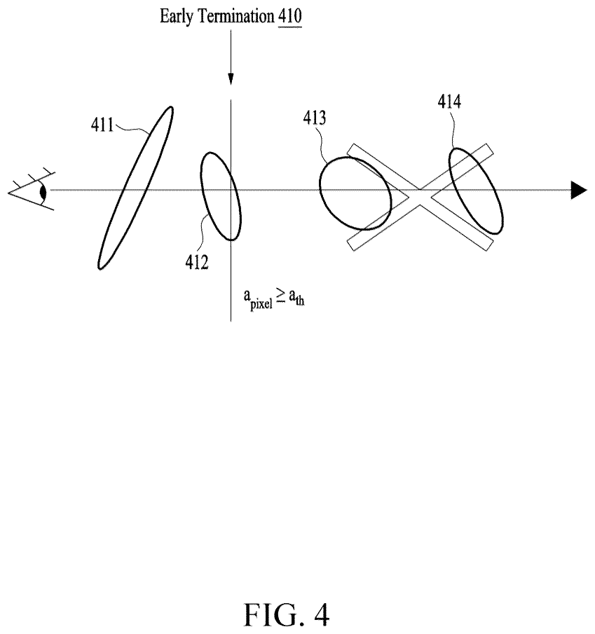

FIG. 4 is a diagram illustrating an example of an early termination using an alpha value, according to an embodiment. Referring to FIG. 4, in the process of blending fragments of a pixel based on a first Gaussian 411, a second Gaussian 412, a third Gaussian 413, and a fourth Gaussian 414, the blending of the fragments of the pixel may be terminated early based on an alpha value of the pixel being greater than or equal to a threshold value αₜₕ. FIG. 4 illustrates an example in which a pixel alpha αₚᵢₓₑₗ is greater than or equal to the threshold value αₜₕ in the blending process based on fragments of the second Gaussian 412. In this case, due to an early termination 410, the third Gaussian 413 and the fourth Gaussian 414 may not affect the blending of the pixel. According to an embodiment, the early termination 410 may be performed based on hardware.

According to an embodiment, the following operations may be performed to implement the early termination 410 at the hardware level. First, rendering may be performed according to a process which does not include the early termination 410. According to an embodiment, an ROP may include a first ROP (e.g., a color ROP (CROP)) configured to process color data and a second ROP (e.g., a depth ROP (ZROP)) configured to process depth data, but embodiments are not limited thereto. The first ROP may perform blending and compare an alpha value with (or to) the threshold value αₜₕ. Based on an alpha value of a predetermined pixel exceeding the threshold value αₜₕ, the first ROP may transmit a signal to the second ROP to prevent additional fragment shading and alpha blending for the corresponding pixel. The second ROP that receives the signal may display or indicate that the corresponding pixel is terminated early at a corresponding position of the corresponding pixel in a predetermined buffer.

In addition, for a fragment on which rasterization is performed, the second ROP may continuously inspect whether the fragment is terminated early and may discard a fragment that is marked as being terminated early. The pixel that is marked as being terminated early may have already accumulated enough fragments and have a high alpha value, so additional blending for the pixel may have little or no effect on the final result value of the pixel. Accordingly, by efficiently implementing the early termination 410, the fragments that have little effect on the final output image may be effectively removed, thereby increasing the rendering speed.

Implementing the early termination 410 at the hardware level may indicate higher efficiency and speed improvement than a software-level implementation. The early termination 410 at the hardware level may be used or may not be used through a graphics API. Accordingly, the early termination 410 may be compatible with a program that is designed without considering the early termination 410.

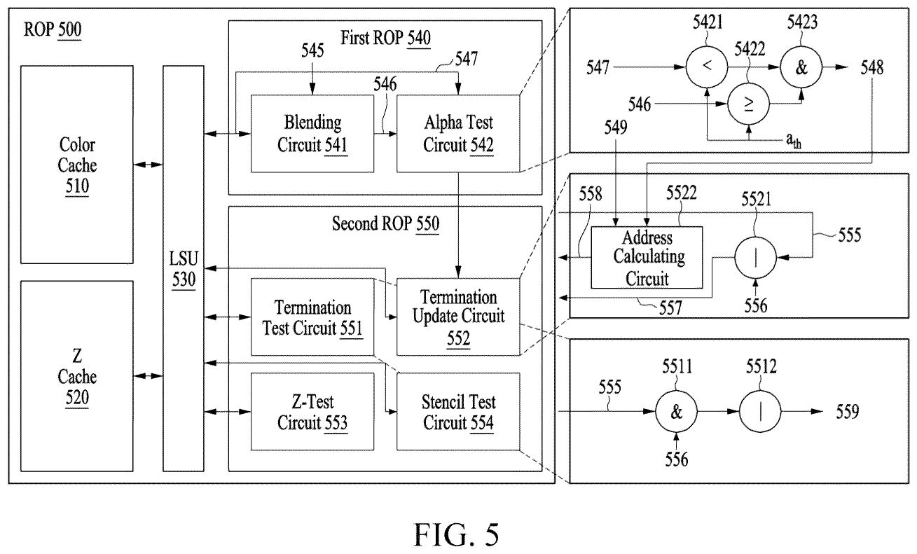

FIG. 5 is a diagram illustrating an example of a configuration of a GPU that may perform an early termination, according to an embodiment. Referring to FIG. 5, an ROP 500 may include a color cache 510, a Z cache 520, a load store unit (LSU) 530, a first ROP 540, and a second ROP 550. The first ROP 540 may process color data, and the second ROP 550 may process depth data. However, embodiments are not limited thereto. The color cache 510 may be used by the first ROP 540, and the Z cache 520 may be used by the second ROP 550. However, embodiments are not limited thereto. The first ROP 540 may include a blending circuit 541 and an alpha test circuit 542, and the second ROP 550 may include a termination test circuit 551, a termination update circuit 552, a Z-test circuit 553, and a stencil test circuit 554.

According to embodiments, the blending circuit 541 may perform a blending operation included in a graphics pipeline, the Z-test circuit 553 may perform a depth test (which may be referred to as a Z-test) included in the graphics pipeline, and the stencil test circuit 554 may perform may perform a stencil test included in the graphics pipeline. According to an embodiment, the alpha test circuit 542, the termination test circuit 551, and the termination update circuit 552 may be added to implement a hardware-based early termination. FIG. 5 illustrates an example in which the alpha test circuit 542 is disposed in the first ROP 540, and the termination test circuit 551 and the termination update circuit 552 are disposed in the second ROP 550. However, embodiments are not limited thereto. For example, in some embodiments, the alpha test circuit 542, the termination test circuit 551, and the termination update circuit 552 may be disposed at different positions in the ROP 500. In addition, in some embodiments, the alpha test circuit 542, the termination test circuit 551, and the termination update circuit 552 may be disposed at positions inside the GPU but outside the ROP 500.

According to an embodiment, the first ROP 540 may be implemented as follows. The first ROP 540 may compare an alpha value of a pixel of an output image before or after blending with a threshold value αₜₕ and may test whether the pixel should be terminated early. The first ROP 540 may have a channel that may transmit a signal to the second ROP 550 after determining that the pixel is terminated early.

According to an embodiment, an alpha test may be performed by comparing both an alpha value before blending and an alpha value after blending with the threshold value αₜₕ. In this case, up to one early termination signal may be transmitted to the second ROP 550 for one pixel. In this case, the signal transmitted to the second ROP 550 may be limited to a maximum of one time per pixel in the same frame. Accordingly, the signal channel may operate efficiently. In addition, recording an early termination in the second ROP 550 may also be limited to a maximum of one time per pixel position. Accordingly, unnecessary memory operations may be prevented.

According to an embodiment, the threshold value αₜₕ may be changed by a user through a graphics API. The early termination may be performed more effectively by changing the threshold value αₜₕ according to display environments, preferences, image characteristics, or the like of an API user or a device user.

The second ROP 550 may receive the signal transmitted from the first ROP 540 and change a termination value of a corresponding position of a pixel in a predetermined buffer. In addition, the second ROP 550 may test, by checking the buffer, whether a pixel corresponding to a fragment is terminated early for each input fragment and may determine whether to discard the fragment. In the example illustrated in FIG. 5, the second ROP 550 may perform a stencil test together with an early termination test. The depth test may be performed together with the stencil test, just as before adding units related to the early termination. Additionally, in the example illustrated in FIG. 5, although some bits (e.g., most significant bits (MSBs)) of a previously used characteristic value may be used to store a state of the early termination, various techniques for storing the early termination value may be used, such as using a separate buffer. In embodiments, the characteristic value may include, for example, at least one from among a stencil value and a Z value (which may also be referred to as a depth value).

According to an embodiment, the GPU may include the termination test circuit 551, the blending circuit 541, the alpha test circuit 542, and the termination update circuit 552.

The termination test circuit 551 may receive, from a memory (e.g., the Z cache 520, the L2 cache, and the VRAM), an early termination value of a first pixel of an output image. The first pixel may be one of a plurality of pixels of the output image. Hereinafter, the description of the first pixel may also be applied to other pixels of the output image. The memory may store an early termination value corresponding to each pixel. The memory may match and store early termination values with pieces of corresponding pixel information.

According to an embodiment, the early termination value may be stored in a characteristic value. For example, the characteristic value of the first pixel may be multi-bit data, and the early termination value of the first pixel may be single-bit data in the multi-bit data of the characteristic value. The characteristic value may represent a rendering characteristic of a corresponding pixel. For example, previously used data (e.g., data used earlier in the pipeline), such as a stencil value or a Z value, may be used as the characteristic value. The termination test circuit 551 may receive, from the memory, the characteristic value of the first pixel, which may include the early termination value of the first pixel, and may extract the early termination value from the characteristic value.

The termination test circuit 551 may output a termination test result by performing a termination test on a first fragment for the first pixel based on the early termination value. According to the rasterization, one or more fragments may be determined for each pixel of the output image. The first fragment may be one of one or more fragments for the first pixel. The termination test result may indicate whether the first pixel is terminated early and whether to discard a current fragment. For example, if the termination test result is true (e.g., a true termination test result), this may indicate that the first pixel is terminated early. As another example, if the termination test result is false (e.g., a false termination test result), this may indicate that the first pixel is not terminated early. Additionally, the true termination test result may indicate that the current fragment should be discarded, and the false termination test result may indicate that the current fragment should not be discarded. Whether the termination test result is true or false may be distinguished according to the level of an output signal of the termination test circuit 551 corresponding to the termination test result.

The blending circuit 541 may determine a new pixel value of the first pixel by performing a blending operation using the first fragment based on the termination test result or omit the blending operation. The blending circuit 541 may perform the blending operation based on the termination test result being false, and may omit the blending operation based on the termination test result being true. Omitting the blending operation may mean that the blending operation is not performed. For example, when the first pixel is terminated early, blending using an additional fragment (e.g., a second fragment of the first pixel) for the first pixel may not be performed.

The blending circuit 541 may determine the new pixel value by blending a source pixel value 545 with an old pixel value. The source pixel value 545 may be received from a fragment shader, and the old pixel value may be received from the memory. The pixel value may include a color value and an alpha value. For example, the pixel value may have a red, green, blue, and alpha (RGBA) format. The RGBA format may include a red value, a green value, a blue value, and an alpha value. The alpha value may indicate transparency.

When the blending operation is performed (e.g., based on the termination test result being false), the alpha test circuit 542 may perform an alpha test by comparing an alpha value 546 of the new pixel value of the first pixel with the threshold value αₜₕ and may output an alpha test result. When the blending operation is not performed (e.g., based on the termination test result being true), the alpha test circuit 542 may not perform the alpha test because there is no new pixel value to be tested. The alpha test result may indicate whether to terminate the first pixel early. For example, if the alpha test result is true (e.g., a true alpha test result), this may indicate that the first pixel should be terminated early. As another example, if the termination test result is false (e.g., a false alpha test result), this may indicate that the first pixel should not be terminated early. Whether the alpha test result is true or false may be distinguished according to the level of an output signal of the alpha test circuit 542 corresponding to the alpha test result.

According to an embodiment, the alpha test circuit 542 may perform the alpha test by using the alpha value 546 of the new pixel value and an alpha value 547 of the old pixel value. The alpha value 546 may be received from the blending circuit 541, and the alpha value 547 may be received from the memory. The alpha test circuit 542 may output the alpha test result indicating the early termination based on the alpha value 546 of the new pixel value of the first pixel being greater than or equal to the threshold value αₜₕ and the alpha value 547 of the old pixel value of the first pixel being less than the threshold value αₜₕ.

Based on the alpha test result indicating the early termination, the termination update circuit 552 may update the early termination value of the first pixel. For example, based on the alpha test result for the first fragment of the first pixel indicating the early termination, the termination update circuit 552 may update the early termination value of the first pixel from false (e.g., a value of zero (“0”)) to true (e.g., a value of one (“1”)) because the first pixel should be terminated early. For example, the termination update circuit 552 may maintain the early termination value of the first pixel as a value of zero (“0”)) based on the alpha test result being false, and may update the early termination value of the first pixel to a value of one (“1”) based on the alpha test result being true.

An example of the alpha test circuit 542, the termination update circuit 552, and the termination test circuit 551 is shown on the right side of FIG. 5. However, this is an example, and the alpha test circuit 542, the termination update circuit 552, and the termination test circuit 551 are not limited thereto.

According to an embodiment, the termination test circuit 551 may include an AND operation circuit 5511, which may perform an AND operation between a characteristic value 555 and a one-hot value 556 based on a bit position of the early termination value in the characteristic value 555 of the first pixel, and an OR operation circuit 5512, which may perform an OR operation between bits of output data of the AND operation circuit 5511. The one-hot value 556 may have the same number of bits as the characteristic value 555, and one of the bits of the one-hot value 556 may be a value of one (“1”)and the rest may be a value of zero (“0”).

For example, the characteristic value 555 may be 8-bit data, and the early termination value may be 1-bit data included in an MSB of the characteristic value 555. In this case, the one-hot value 556 may be a value of “1000000”. Based on the early termination value being a value of one (“1”) the output data of the AND operation circuit 5511 may be a value of “1000000”. In this case, a termination test result 559 may have a level corresponding to a value of one (“1”). Based on the early termination value being a value of zero (“0”), the output data of the AND operation circuit 5511 may be “0000000”. In this case, the termination test result 559 may have a level corresponding to a value of zero (“0”). For example, a value of one (“1”)may represent a true termination test result, and a value of zero (“0”) may represent a false termination test result.

According to an embodiment, the alpha test circuit 542 may include a first comparator 5422, which may compare the alpha value 546 of the new pixel value of the first pixel with the threshold value αₜₕ, and a second comparator 5421, which may compare the alpha value 547 of the old pixel value of the first pixel with the threshold value αₜₕ. An AND operation circuit 5423 of the alpha test circuit 542 may generate an alpha test result 548 by performing an AND operation on an output of the first comparator 5422 and an output of the second comparator 5421.

For example, the first comparator 5422 may output a value of one (“1”)based on the alpha value 546 being less than the threshold value αₜₕ, and the second comparator 5421 may output a value of one (“1”) based on the alpha value 547 being greater than or equal to the threshold value αₜₕ. The AND operation circuit 5423 may output a value of one (“1”) indicating the early termination as the alpha test result 548 based on both the output of the first comparator 5422 and the output of the second comparator 5421 being a value of one (“1”).

According to an embodiment, the termination update circuit 552 may include an address calculating circuit 5522 that may determine a memory address 558 of the early termination value of the first pixel (or a memory address of the characteristic value 555) based on a pixel position 549 of the first pixel in the output image. The termination update circuit 552 may update the early termination value of the first pixel by using the memory address 558 of the early termination value. The address calculating circuit 5522 may be activated based on the alpha test result 548. For example, based on the alpha test result 548 being a value of one (“1”), the address calculating circuit 5522 may be activated so that the memory address 558 of the pixel position 549 may be output.

The termination update circuit 552 may include an OR operation circuit 5521. The characteristic value 555 may be received from the memory based on the pixel position 549 of the first pixel. The termination update circuit 552 may perform an OR operation on the characteristic value 555 and the one-hot value 556. Based on the early termination value based on “0”, the early termination value may be changed from a value of zero (“0”) to a value of one (“1”) according to the OR operation. The operation result 557 corresponding to a new characteristic value may be stored in the memory based on the memory address 558. The storage to the memory may be performed based on the alpha test result 548 being a value of one (“1”).

The blending circuit 541, the alpha test circuit 542, the termination test circuit 551, the termination update circuit 552, the Z-test circuit 553, and the stencil test circuit 554 may each include a hardware circuit and/or a hardware logic. The blending circuit 541, the alpha test circuit 542, the termination test circuit 551, the termination update circuit 552, the Z-test circuit 553, and the stencil test circuit 554 may be physically separated from each other or logically separated from each other, but embodiments are not limited thereto. Unless otherwise stated, each circuit block described below may include a hardware circuit and/or a hardware logic and may be physically separated from each other or logically separated from each other, but embodiments are not limited thereto.

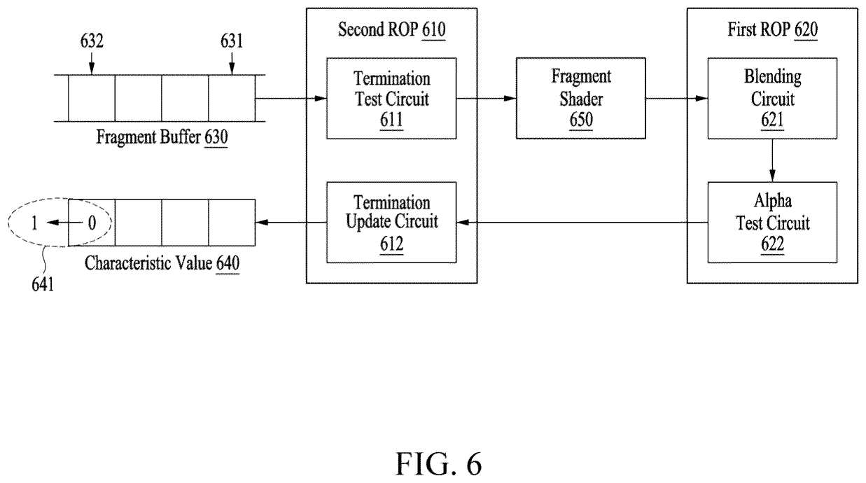

FIG. 6 is a diagram illustrating an example of a process of updating an early termination value of a predetermined pixel, according to an embodiment. Referring to FIG. 6, a fragment buffer 630 may store a first fragment 631 of a first pixel and a second fragment 632 of the first pixel. The fragment buffer 630 may be a first-in-first-out (FIFO) buffer and may store fragments according to rasterization.

A second ROP 610 may include a termination test circuit 611 and a termination update circuit 612. The termination test circuit 611 may receive, from a memory, an early termination value 641 of the first pixel and may perform a termination test on the first fragment 631 based on the early termination value 641. FIG. 6 illustrates an example in which the early termination value 641 is included in the MSB of a characteristic value 640. However, embodiments are not limited thereto. In this case, other bits of the characteristic value 640 (e.g., a stencil value and a Z value) may be used for the original purpose (e.g., a stencil test and a depth test). Based on a termination test result being false, a fragment shader 650, a blending circuit 621, an alpha test circuit 622, and the termination update circuit 612 may operate based on the first fragment 631.

The fragment shader 650 may perform fragment shading on the first fragment 631. Accordingly, a source pixel value of the first fragment 631 may be determined. A first ROP 620 may include the blending circuit 621 and the alpha test circuit 622. The blending circuit 621 may determine a new pixel value of the first pixel by blending an old pixel value of the first pixel with the source pixel value. The alpha test circuit 622 may perform an alpha test by comparing an alpha value of the new pixel value of the first pixel with a threshold and may output an alpha test result. The termination update circuit 612 may update the early termination value 641 based on the alpha test result. For example, based on the alpha test result indicating an early termination, the termination update circuit 612 may update the early termination value 641 from a value of zero (“0”) to a value of one (“1”).

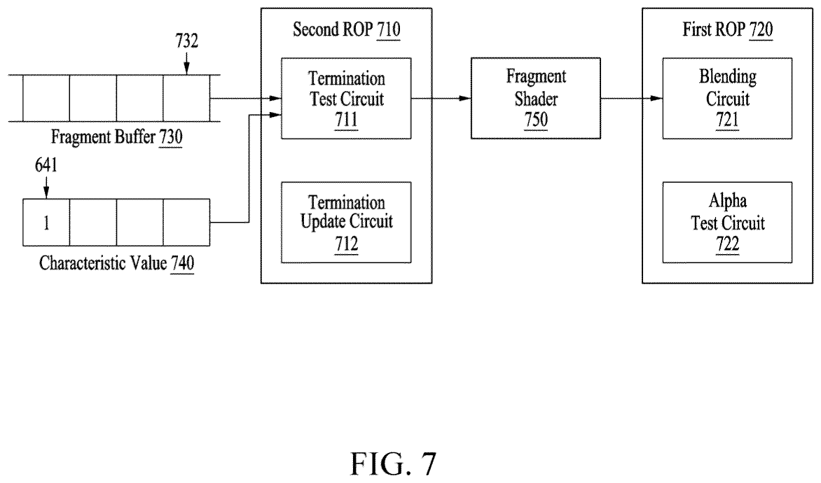

FIG. 7 is a diagram illustrating an example of a process of omitting the processing of a fragment of a predetermined pixel based on an early termination value of the predetermined pixel, according to an embodiment. FIG. 7 may represent a situation temporally after FIG. 6. Referring to FIG. 7, a fragment buffer 730 may store a second fragment 732 of a first pixel. A second ROP 710 may include a termination test circuit 711 and a termination update circuit 712. The termination test circuit 711 may receive, from a memory, an early termination value 741 of the first pixel and may perform a termination test on the second fragment 732 based on the early termination value 741. Based on the termination test result being true, the second fragment 732 may be discarded, and the operations of a fragment shader 750, a blending circuit 721, an alpha test circuit 722, and the termination update circuit 712 for the second fragment 732 may be omitted. The second fragment 732 may not move on to the next pipeline stage, fragment shading and blending.

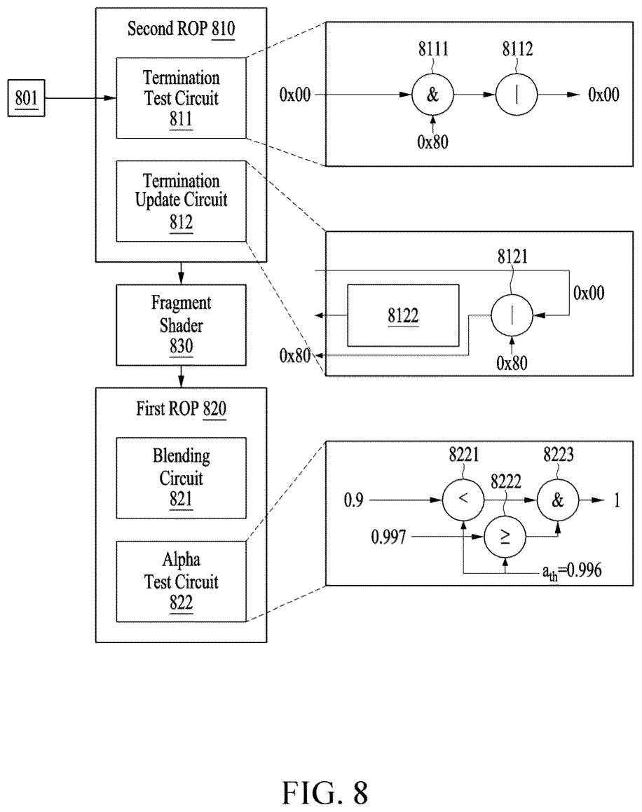

FIG. 8 is a diagram illustrating a detailed example of early termination processing, according to an embodiment. Referring to FIG. 8, a second ROP 810 may include a termination test circuit 811 and a termination update circuit 812. The termination test circuit 811 may perform a termination test on a first fragment 801 of a first pixel. According to an embodiment, an early termination value may be included in a characteristic value. In this case, the termination test circuit 811 may extract an early termination value from the characteristic value. A unit for reading the characteristic value (e.g., a stencil value) may exist in another circuit configuration (e.g., a stencil test circuit), and some bits (e.g., MSBs) of a stencil value may be used, so an additional complex address transformation may not be performed. According to an embodiment, the termination test circuit 811 may include an AND operation circuit 8111 and an OR operation circuit 8112. The characteristic value of the first pixel may be “0×00” and an one-hot value may be “0×80”. In this case, the termination test result may be “0×00”. Accordingly, the first fragment 801 may not be discarded.

A fragment shader 830, a blending circuit 821, an alpha test circuit 822, and the termination update circuit 812 may operate based on the first fragment 801. The fragment shader 830 may perform shading on the first fragment 801. A first ROP 820 may include the blending circuit 821 and the alpha test circuit 822. The blending circuit 821 may determine a new pixel value of the first pixel by performing a blending operation using the first fragment 801. For example, an alpha value of an old pixel value of the first pixel may be “0.9”, and the alpha value of the new pixel value of the first pixel may be “0.997”.

The alpha test circuit 822 may perform an alpha test based on the alpha value of the new pixel value of the first pixel. For example, the alpha test circuit 822 may compare the old alpha value “0.9” with a threshold value αₜₕ by using a first comparator 8221 and may compare the new alpha value “0.997” with the threshold value αₜₕ by using a second comparator 8222. The threshold value αₜₕ may be “0.996”. In this case, the alpha test result of a value of one (“1”) may be output according to an AND operation of an AND operation circuit 8223.

Based on the new alpha value being less than the threshold value αₜₕ, the early termination may not be necessary yet, and based on the old alpha value being greater than or equal to the threshold value αₜₕ, the early termination may have already been performed, so updating the early termination value may not be necessary. Accordingly, performing a comparison operation twice using the first comparator 5422 and the second comparator 5421 may improve channel efficiency and memory access efficiency.

In the example illustrated in FIG. 8, because the alpha test result indicates the early termination, the termination update circuit 812 may update the early termination value of the first pixel. For example, the old early termination value may be “0×00” and the one-hot value may be “0×80”. An output value of “0×80” may be generated according to an OR operation of an OR operation circuit 8121. The early termination value may be updated from “0×00” to “0×80” based on a memory address of the early termination value of the first pixel calculated by an address calculating circuit 8122.

In FIG. 8, the termination test circuit 811 is illustrated as including the AND operation circuit 8111 and the OR operation circuit 8112, but in actual hardware, the operation of the termination test circuit 811 may be solved by connecting a wire to a predetermined bit. Discarding a fragment may be performed using a function included in another circuit configuration (e.g., a stencil test unit). In this case, a discard signal generated from the termination test circuit 811 may be transmitted to the other circuit configuration.

The termination update circuit 812 may receive an alpha test result signal transmitted from the alpha test circuit 822 and may change an early termination value of a corresponding pixel. When a pixel position (e.g., a pixel coordinate) is transmitted to the termination update circuit 812, the termination update circuit 812 (e.g., the address calculating circuit 8122) may calculate an address (e.g., a virtual address and a physical address) of the corresponding pixel. When the address is calculated, a characteristic value (e.g., a stencil value and a Z value) or the early termination value of the corresponding pixel may be loaded from the address using an LSU. The termination update circuit 812 may update the early termination value and then store the updated early termination value in the address. For example, the characteristic value may be loaded from the memory, and the early termination value among the characteristic values may be updated. In this case, the remaining bits other than the early termination value (e.g., the MSB of the characteristic value) may be used by a characteristic processing unit (e.g., a stencil test circuit and a Z-test circuit), so only the early termination value among the characteristic values may be updated.

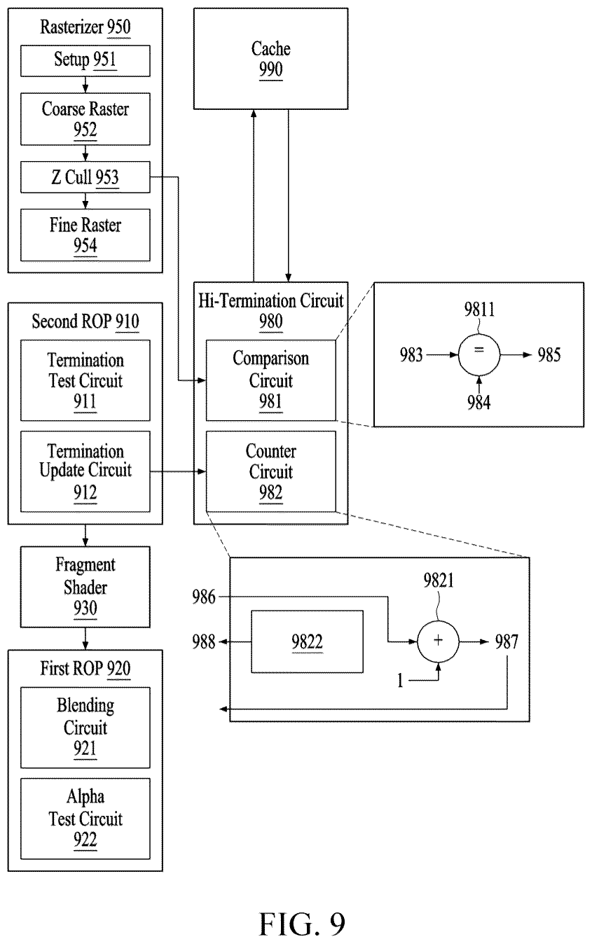

FIG. 9 is a diagram illustrating an example of configurations of a GPU that may perform a hierarchical early termination, according to an embodiment. According to an embodiment, the hierarchical early termination, such as a hierarchical depth or a hierarchical stencil, may be performed. Primary early termination processing may be performed for each pixel group including a plurality of pixels, and secondary early termination processing may be performed for each pixel group on which the primary early termination processing is not performed.

A GPU may perform tile-based rendering. An output image may be split into a plurality of tiles, and the GPU may process the plurality of tiles in parallel. For example, the tiles may be processed in parallel by GPCs included in the GPU. For example, a pixel group, which may be a primary early termination unit, may be a sub-tile, but embodiments are not limited thereto. The output image may include the plurality of tiles, and each tile may include a plurality of sub-tiles.

Because an early termination test may differ from a depth test or a stencil test, the GPU may include additional configurations for the hierarchical early termination. FIG. 9 may represent an example of a configuration for the hierarchical early termination. The hierarchical early termination may have various level configurations, and FIG. 9 may represent an example of a configuration including two hierarchies. In the example illustrated in FIG. 9, a sub-tile may correspond to a tile unit processed by a fine raster operation 954.

Referring to FIG. 9, a rasterizer 950 may perform a setup operation 951, a coarse raster operation 952, a Z cull operation 953, and the fine raster operation 954. In the setup operation 951, the rasterizer 950 may project vertex data output from a vertex shader into a screen space and may determine primitives. In the coarse raster operation 952, the rasterizer 950 may determine a primitive that affects each sub-tile. In the Z cull operation 953, the rasterizer 950 may remove occluded primitives. In the fine raster operation 954, the rasterizer 950 may perform rasterization on the remaining primitives. In this process, the fine raster operation 954 for the occluded primitive may be omitted, so the rendering efficiency may be improved. According to an embodiment, such a hierarchical raster operation may also be applied to an alpha test of volume rendering.

Referring to FIG. 9, the early termination may be performed by a termination test circuit 911 and a termination update circuit 912 of a second ROP 910, a fragment shader 930, and a blending circuit 921 and an alpha test circuit 922 of a first ROP 920. In this process, the hierarchical early termination may be performed using a hierarchical termination circuit 980 (illustrated as “Hi-Termination Circuit”).

The hierarchical termination circuit 980 may include a comparison circuit 981 and a count circuit 982. The termination update circuit 912 may update an early termination value of a pixel requiring an early termination. The count circuit 982 may count the number of pixels updated by the termination update circuit 912 in each sub-tile of the output image. A cache 990 may store a count value of each sub-tile. The comparison circuit 981 may compare the count value of each sub-tile with the size of the sub-tile. A first early termination target may be identified based on the comparison result.

For example, the count circuit 982 may determine a first count value by counting the number of pixels updated by the termination update circuit 912 in a first sub-tile of the output image. According to an embodiment, the count circuit 982 may include a counter 9821 and an address calculating circuit 9822. Based on an early termination value of a pixel of the first sub-tile being updated by the termination update circuit 912, the address calculating circuit 9822 may calculate a first memory address 988 of the first count value of the first sub-tile, and an old first count value 986 may be loaded from a memory (e.g., the cache 990) based on the first memory address 988. The counter 9821 may increase the first count value. For example, the counter 9821 may increase the old first count value 986 by a value of one (“1”). A new first count value 987 may be stored in the memory by using the first memory address 988.

The comparison circuit 981 may compare a current first count value 983 (e.g., the new first count value 987) with the size of the first sub-tile. All sub-tiles may have the same size. The size of the sub-tile may be the number of pixels in the sub-tile. For example, the size of the sub-tile may be 64 (8*8=64). According to an embodiment, the comparison circuit 981 may include a comparator 9811. The comparator 9811 may compare the current first count value 983 with a size 984 of the first sub-tile. The early termination for the first sub-tile may be performed based on an output 985 of the comparison circuit 981. Here, the early termination may correspond to the primary early termination. For example, based on the output 985indicating that the current first count value 983 and the size 984 of the first sub-tile are the same, the early termination for the first sub-tile may be performed.

According an embodiment, an early terminated sub-tile may be identified in the Z cull operation 953. When the early terminated sub-tile exists, rasterization of the sub-tile may be omitted during the fine raster operation 954. For example, based on the first sub-tile being terminated early, fine rasterization of the first sub-tile may be omitted. In this way, when all pixels of predetermined sub-tiles are discarded, rasterization efficiency may be improved by discarding the sub-tiles as a whole. In the fine raster operation 954, the rasterizer 950 may determine fragments for sub-tiles that are not discarded, and raster operations for the fragments of a corresponding sub-tile may be performed in the next pipeline stage. In this process, a secondary early termination may be performed based on each fragment.

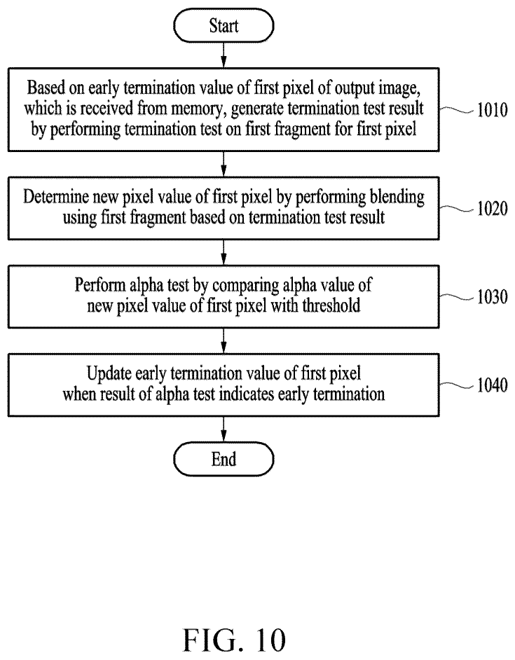

FIG. 10 is a flowchart illustrating an example of an operating method of a GPU, according to an embodiment. Referring to FIG. 10, at operation 1010, based on an early termination value of a first pixel of an output image, which may be received from a memory, the GPU may generate a termination test result by performing a termination test on a first fragment associated with (e.g., corresponding to, including, or included in) the first pixel. At operation 1020, the GPU may determine a new pixel value of the first pixel by performing blending using the first fragment based on the termination test result. At operation 1030, the GPU may perform an alpha test by comparing an alpha value of the new pixel value of the first pixel with (or to) a threshold value. At operation 1040, the GPU may update the early termination value of the first pixel based on the result of the alpha test indicating an early termination.

Operation 1010 may include receiving, from the memory, a characteristic value of the first pixel, which includes the early termination value of the first pixel, and extracting the early termination value from the characteristic value.

The characteristic value of the first pixel may be multi-bit data, and the early termination value of the first pixel may be single-bit data included in the multi-bit data of the characteristic value.

The characteristic value may be a stencil value or a Z value (which may be referred to as a depth value).

Operation 1040 may include determining a memory address of the early termination value of the first pixel based on a pixel position of the first pixel in the output image and updating the early termination value of the first pixel by using the memory address.

The generating of the termination test result may be performed by a termination test circuit of the GPU, the determining of the new pixel value of the first pixel may be performed by a blending circuit of the GPU, the alpha test may be performed by an alpha test circuit of the GPU, and the updating of the early termination value may be performed by a termination update circuit of the GPU.

The GPU may determine a first count value by counting the number of updated pixels in a first sub-tile of the output image and may compare the first count value with the size of the first sub-tile. The early termination for the first sub-tile may be performed based on the comparison result.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For simplicity, the processing device is described above as singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

Although some embodiments are described above with reference to the limited drawings, one of ordinary skill in the art may apply various technical modifications and variations based thereon without departing from the scope of the disclosure. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A graphics processing unit (GPU) comprising:
a termination test circuit configured to:
receive, from a memory, an early termination value of a first pixel included in an output image, and to output a termination test result by performing a termination test on a first fragment associated with the first pixel based on the early termination value;
a blending circuit configured to, based on the termination test result, determine a new pixel value of the first pixel by performing blending using the first fragment, or to omit the blending;
an alpha test circuit configured to perform an alpha test by comparing an alpha value of the new pixel value to a threshold value when the blending is performed, and to output an alpha test result; and
a termination update circuit configured to update the early termination value based on the alpha test result indicating an early termination.

2. The GPU of claim 1, wherein the blending circuit is further configured to perform the blending based on the termination test result being a false termination test result, and to omit the blending based on the termination test result being a true termination test result.

3. The GPU of claim 1, wherein the termination update circuit is further configured to maintain the early termination value based on the alpha test result being a false alpha test result, and to update the early termination value based on the alpha test result being a true alpha test result.

4. The GPU of claim 1, wherein the termination test circuit is further configured to:
receive, from the memory, a characteristic value of the first pixel, wherein the characteristic value comprises the early termination value, and
extract the early termination value from the characteristic value.

5. The GPU of claim 4, wherein the characteristic value of the first pixel comprises multi-bit data, and
wherein the early termination value comprises single-bit data included in the multi-bit data.

6. The GPU of claim 4, wherein the termination test circuit comprises:
an AND operation circuit configured to perform an AND operation between the characteristic value and a one-hot value based on a bit position of the early termination value in the characteristic value to generate output data; and
an OR operation circuit configured to perform an OR operation between bits included in the output data.

7. The GPU of claim 4, wherein the characteristic value comprises a at least one from among a stencil value and a depth value.

8. The GPU of claim 1, wherein the alpha test circuit is further configured to output the alpha test result indicating the early termination based on the alpha value of the new pixel value being greater than or equal to the threshold value, and an alpha value of an old pixel value of the first pixel being less than the threshold value.

9. The GPU of claim 8, wherein the alpha test circuit comprises:
a first comparator configured to compare the alpha value of the new pixel value to the threshold value; and
a second comparator configured to compare the alpha value of the old pixel value to the threshold value.

10. The GPU of claim 1, wherein the termination update circuit is further configured to:
determine a memory address of the early termination value based on a pixel position of the first pixel in the output image, and
update the early termination value using the memory address.

11. The GPU of claim 1, wherein the termination test circuit, the blending circuit, the alpha test circuit, and the termination update circuit are included in a raster operation pipeline (ROP) of the GPU.

12. The GPU of claim 11, wherein the blending circuit and the alpha test circuit are included in a first ROP configured to process color data in the ROP, and
wherein the termination test circuit and the termination update circuit are included in a second ROP configured to process depth data in the ROP.

13. The GPU of claim 1, further comprising:
a count circuit configured to determine a first count value by counting a number of pixels updated by the termination update circuit in a first sub-tile of the output image; and
a comparison circuit configured to compare the first count value to a size of the first sub-tile,
wherein an early termination for the first sub-tile is performed based on an output of the comparison circuit.

14. An operating method of a graphics processing unit (GPU), the operating method comprising:
receiving, from a memory, an early termination value of a first pixel included an output image;
based on the early termination value, generating a termination test result by performing a termination test on a first fragment associated with the first pixel;
determining a new pixel value of the first pixel by performing blending using the first fragment based on the termination test result;
performing an alpha test by comparing an alpha value of the new pixel value to a threshold value; and
updating the early termination value based on a result of the alpha test indicating an early termination.

15. The operating method of claim 14, wherein the generating of the termination test result comprises:
receiving, from the memory, a characteristic value of the first pixel, wherein the characteristic value comprises the early termination value; and
extracting the early termination value from the characteristic value.

16. The operating method of claim 15, wherein the characteristic value comprises multi-bit data,
wherein the early termination value of the first pixel comprises single-bit data included in the multi-bit data.

17. The operating method of claim 15, wherein the characteristic value comprises at least one from among a stencil value and a depth value.

18. The operating method of claim 14, wherein the updating of the early termination value comprises:
determining a memory address of the early termination value based on a pixel position of the first pixel in the output image; and
updating the early termination value using the memory address.

19. The operating method of claim 14, wherein the generating of the termination test result is performed by a termination test circuit included in the GPU,
wherein the determining of the new pixel value of the first pixel is performed by a blending circuit included in the GPU,
wherein the alpha test is performed by an alpha test circuit included in the GPU, and
wherein the updating of the early termination value is performed by a termination update circuit included in the GPU.

20. The operating method of claim 14, further comprising:
determining a first count value by counting a number of updated pixels included in a first sub-tile of the output image; and
comparing the first count value to a size of the first sub-tile,
wherein an early termination for the first sub-tile is performed based on a result of the comparing.
